(19) United States
(12) Patent Application Publication
(10) Pub. No.: US 2006/0100946 A1
(43) Pub. Date: May 11, 2006

(54) Co-investment structure with multi-option hurdle rate alternatives for performance based asset allocation

(76) Inventor: Paul B. Kazarian, Providence, RI (US)

Correspondence Address: EDWARDS & ANGELL, LLP, P.O. BOX 55874, BOSTON, MA, 02205, US

(21) Appl. No.: 11/271,314

(22) Filed: Nov. 10, 2005

Related U.S. Application Data
(60) Provisional application No. 60/626,581, filed on Nov. 10, 2004.
(60) Provisional application No. 60/671,847, filed on Apr. 15, 2005.

(51) Int. Cl. G06Q 40/00

(52) U.S. Cl. 705/35

(57) ABSTRACT

A co-investment structure that aligns interests among investors and investment managers by creating pure performance based compensation for the investment manager while overcoming the conundrum facing asset allocators in selecting investment managers. The co-investment structure provides cash-based evaluation of performance and offers multi-option hurdle rate alternatives that accommodate the performance benchmarks of major asset classes while establishing a compensation structure using granular stratification of relative performance. The co-investment structure bases investment manager compensation solely on excess profits, actually cultivating entrepreneurial returns. In particular, the best entrepreneurial investment managers, singularly focused on achieving excess profit with respect to a top quartile benchmark, excel with the co-investment structure.

### CROSS-REFERENCE TO RELATED APPLICATION

This application claims priority to U.S. Provisional Patent Application No. 60/626,581, filed Nov. 10, 2004, and U.S. Provisional Patent Application No. 60/671,847, filed Apr. 15, 2005, each of which is incorporated herein by reference.

### BACKGROUND OF THE INVENTION

1. Field of the Invention

The subject disclosure is directed to allocating assets in a co-investment structure and, more particularly to aligning interests among investors and investment managers by creating pure performance based compensation for the investment manager. The subject disclosure is further directed to providing cash-based evaluation of performance and offering multi-option hurdle rate alternatives that establish a compensation structure with granular stratification of relative performance.

2. Background of the Related Art

In the modern business climate, many multi-billion dollar, global companies are underperforming and inefficient. These value gaps create opportunities to be capitalized upon, yet invested capital that seeks such opportunities is often misdirected. The existing fee heavy mechanisms to deploy capital and mine such opportunities are inefficient. Rather than motivate fiduciaries to maximize return, the result is often to line the pockets of asset gathering, cash rich fiduciaries without providing incentive to find the value gaps and create value through proper management. Without aligned interests between the fiduciaries and investors, inefficient corporate and investment cultures are fostered to the detriment of all parties except those fiduciaries who extract large fees without regard to performance.

Referring to FIG. 1, a typical structure 100 within which assets are employed is shown. It is envisioned that endless variations upon the specific example given are possible as would be appreciated by those of ordinary skill in the art. For example, an employee 102 participates in a companies 401k or pension program to create a large pool of employee money. The employee money is managed by professional money managers 104. Professional money managers 104 may be institutions and the like that specialize in allocating assets for businesses and individuals. As shown in the compensation legend 114, professional money managers 104 often extract a 1% plus fee of total assets in return for the services rendered.

In an attempt to effectively distribute what may be large amounts of assets, the professional money managers or fiduciary managers 104 engage fund-of-fund managers 108. Often, in order to access the fund-of-fund managers 108, the fund-of-fund managers 108 must endure a vetting process as administered by advisors 106 to the money managers 104. Of course the money managers 104, and in turn the employees, must pay the advisors 106 and the fund-of-fund managers 108 handsome fees. An advisor 106 typically garners a fixed fee where the fund-of-fund managers 108 may require 5% of the profits plus a 1% management fee.

Once the employee's assets come under the control of the fund-of-fund managers 108, the assets are further distributed to alternative asset managers 110 such as hedge fund managers, private equity managers, money managers and the like. The alternative asset managers 110 employ individual managers 112 who ultimately make the funds available to companies in need of financing. Again, the alternative asset managers 110 and individual managers 112 not only charge a point or two as a management fee but take and additional 10-20% of the profits as compensation before the employees 102 participate in the profit. Personnel 116 at the target companies receive industry standard incentive compensation such as options, restricted stock and large cash bonuses.

As can be seen from above, the interests, e.g., compensation, of many of the entities 104, 106, 108 and 112 in the structure 100 are aimed at acquiring large amounts of assets to manage rather than optimizing return to the employees 102. Thus, despite the sophistication in the high finance marketplace, the existing structure does not align the interests of all parties involved. Further, a complex multi-layer network has evolved to provide access to all the investment vehicles that a professional money manager 104 may desire. Moreover, each layer adds an additional expense that dampens potential return to the ultimate vested party, the employees 102.

Academics, investors and others have studied the existing structure 100 and have suggested incremental changes or resigned themselves to the current structure. David F. Swensen, the Chief Investment Officer of Yale University, even wrote a book entitled “Pioneering Portfolio Management: An Unconventional Approach to Institutional Investment”, that comments on the current state of the art. Swensen states “[l]ike the residents of Lake Wobegon who all believe their children to be above average, all investors believe their active strategies will produce superior results. The harsh reality of the negative-sum game dictates that in the aggregate, active managers lose to the market by the amount it costs to play.” Swensen makes a strong case for importance of selecting the best asset managers in private markets because, he observes, the median results for venture capital and leverage buyouts, for example, dramatically trail those for marketable equities despite the higher risk and greater illiquidity of private investing. Thus, Swensen concludes that “[I]n order to justify including private equity in the portfolio, investors must believe they can select top-quartile managers.”

Despite the conundrum in identifying above-average investment managers and linking pay to performance to align interests, Swensen is resigned to the fact that industry-wide change cannot occur because manager by manager personal career choices prohibit a “fair deal structure”. The fundamental principle according to Swensen is that a “fair deal structure” would necessarily compensate managers at a lower level. Thus, Swensen laments “[t]he innovative private fund offering a fair deal, retains only those principals without other alternatives”.

Further, many managers 108, 110, 112 state various measures of return such as gross or net internal rates of return or simple price appreciation versus total return of an index for evaluating their performance. As a result, fiduciary managers 104 are often mislead or unable to evaluate their options which leads to disappointing outcomes. Unrealized investment or interim valuation assumptions are an opportunity for fiduciaries to misrepresent their performance. An alternative method that yields easy evaluation of performance without opportunity for accounting abuse would greatly benefit fiduciary managers 104.

### SUMMARY OF THE INVENTION

Accordingly, it would be beneficial to provide a co-investment structure for allocating assets in which the parties interests are aligned, unnecessary layers of cost are removed and assets are efficiently employed while accommodating the performance benchmarks of multiple asset classes. The co-investment structure bases investment manager compensation solely on excess profits, actually cultivating entrepreneurial returns. In particular, the best entrepreneurial investment managers, singularly focused on achieving excess profit with respect to a top quartile benchmark, excel with the co-investment structure.

It is an object of the subject technology to provide a method for blending hurdle alternatives to provide asset allocators and accomplished investors with choice and flexibility related to generating entrepreneurial incentive for the investment manager.

It is another object to determine investment manager incentives according to a compensation structure with granular stratification of relative performance.

It is still another object of the subject technology to provide an asset distribution system in which money managers are reluctant to stockpile assets unless the assets can be effectively employed.

It is yet another object of the subject technology to provide a financial product with superior performance for investors and entrepreneurial level compensation for the provider of the financial product. The financial product is further structured to entice investors and managers while restraining investment unless significant opportunities are present.

It is an object to motivate investment managers with the track record and ability to provide entrepreneurial returns to accomplished investors who succeed with top quartile performance.

In one embodiment, the subject technology is a multi-option hurdle rate where, before the management team participates, the investment manager 150 must return 100% of the initial capital and meet one or a blend of hurdle rate alternatives: a 15% fixed internal rate of return; 1,000 basis point over 3-month Treasury bills; or 500 basis points over S&P 500; 500 basis points over the S&P 400; 500 basis points over the MSCI Europe Stock Index; MSCI World; top quartile hedge fund index; and top quartile private equity index. After the hurdle rate (positive or negative) is met, the investors and investment manager split excess profits equally. A hard hurdle rate is typically a single criteria or minimum return that must be met before a carry is permitted, i.e., the excess profits are shared.

In another embodiment, the subject technology is directed to a financial product offered by an entity to an investor including a plurality of indices, a plurality of hurdles based on the plurality of indices, wherein each hurdle is selected by the investor for a portion of an investment of the investor. A blended hurdle is calculated as a weighted average of the selected hurdles according to allocation of the portions of the investment and a stratified compensation schedule associated with the blended hurdle such that as a return of the financial product increases above the blended hurdle, compensation for the entity increases.

In yet another embodiment, the subject technology is an entity having employees that deploys assets, cash and the like. The co-investment financial structure of the entity is such that a stratified compensation schedule motivates employees to excel. The stratified compensation schedule is associated with hurdles such that as a return on the assets exceeds the hurdles, the incentive compensation for the core employees is based on a percentage of the return in excess of the hurdles instead of stock options and restricted stock options.

Another embodiment of the subject technology is a method for allocating investment assets of an institutional investor stakeholder including the steps of providing an option for determining employment of a portion of the investment funds, the option being directed to those asset managers seeking a fixed return on their assets, such as wealthy individuals or endowments, providing an option for determining employment of a portion of the investment funds, the option being directed to those asset managers whose performance is measured relative to one of many stock-related stock indices, such as mutual funds or financial advisors and providing an option for determining employment of a portion of the investment funds, the option being directed to whose performance is measure relative to some fixed income or low volatility index, such as hedge funds or other absolute return managers.

It should be appreciated that the present invention can be implemented and utilized in numerous ways, including without limitation as a process, an apparatus, a system, a device, a method for applications now known and later developed or a computer readable medium. These and other unique features of the system disclosed herein will become more readily apparent from the following description and the accompanying drawings.

### BRIEF DESCRIPTION OF THE DRAWINGS

So that those having ordinary skill in the art to which the disclosed system appertains will more readily understand how to make and use the same, reference may be had to the drawings.

FIG. 1 is a hierarchical chart illustrating managerial levels in an asset allocation structure in a typical environment.

FIG. 1A is a hierarchical chart illustrating managerial levels in an asset allocation structure in an environment with an entity in accordance with the subject technology.

FIG. 2 is table of exemplary data comparing hurdle rate alternatives over historical periods.

FIG. 3A is a table of exemplary data ranking index performance with an associated compensation scheme in accordance with the subject technology.

FIG. 3B is a table of exemplary data ranking index performance with an associated compensation scheme in accordance with the subject technology.

FIG. 4 is a graph of exemplary performance data in accordance with the subject technology.

### DETAILED DESCRIPTION OF PREFERRED EMBODIMENTS

The present invention overcomes many of the prior art problems associated with managers of invested capital by using a co-investment structure with multi-option hurdle rate alternatives for performance based asset allocation. The advantages, and other features of the system disclosed herein, will become more readily apparent to those having ordinary skill in the art from the following detailed description of certain preferred embodiments which set forth representative embodiments of the present.

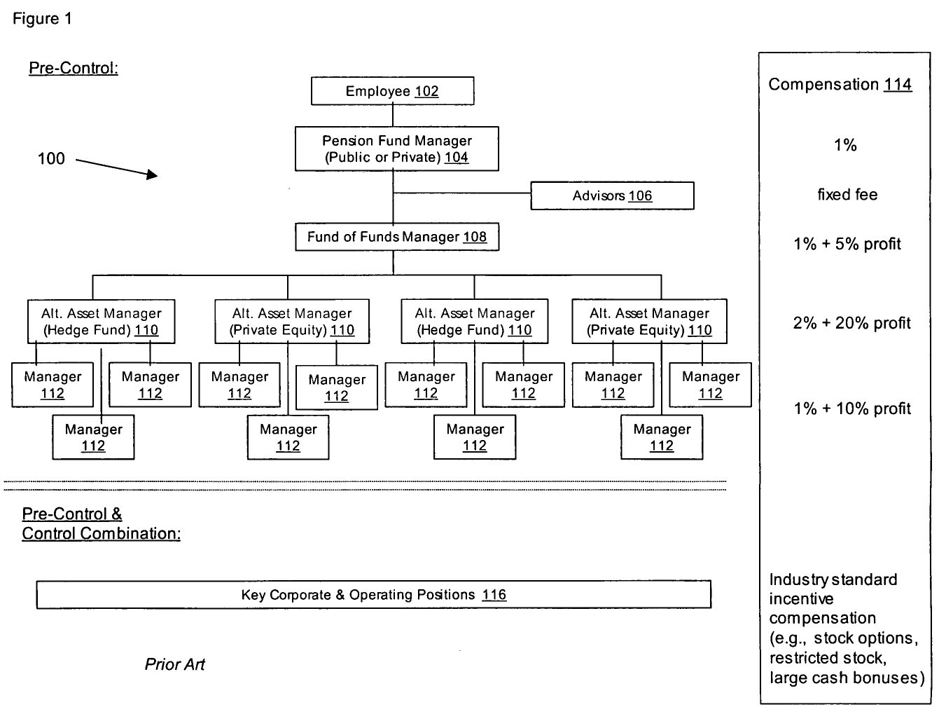

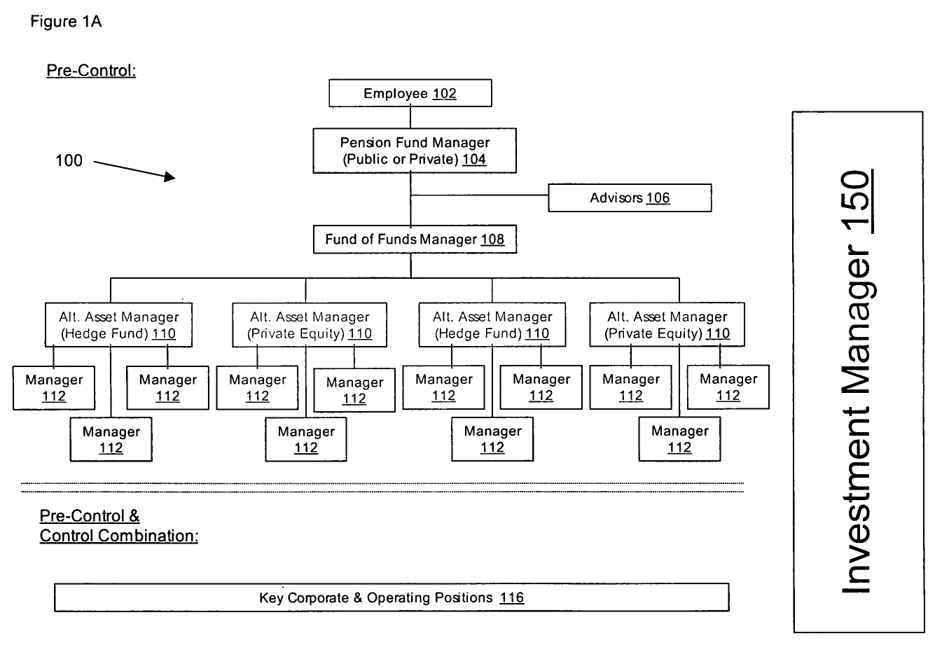

Referring to FIG. 1A, an investment manager 150 interacts with one or more layers within the structure 100. As the layers are replaced, the corresponding cost or overhead to the employees 102 is removed. For example, the investment manager 150 may be employed by the fiduciary manager 104 to invest a certain sum of money. Rather than reallocate the money to other managers without accountability, the investment manager 150 receives the money under condition of multi-option hurdle rates. In the event that the investment manager 150 does not exceed the selected hurdle rate(s), the investment manager 150 forgoes all or a substantial part of its compensation. In a preferred embodiment, no management fee is paid to the investment manager 150. The investment manager 150 only receives compensation related to profits in excess of the relevant hurdle rate. For example, the investment manager 150 may receive 50% of the post hurdle rate excess profit. It is envisioned that the division of profits in excess of the hurdle rate may vary. Accordingly, it can be seen that the investment manager 150 does not have an incentive to acquire large amounts of assets in order to collect management fees while not effectively employing the money. Rather, the investment manager 150 has the same interest as the employees 102, i.e., to maximize the return on the investment, and without striving and achieving this goal, the investment manager 150 relinquishes compensation.

In still another embodiment, the investment manager 150 interacts directly with the entity providing the investment capital 102. Such an entity 102 may be a high-net worth individual, a family office, a trust fund owner or fiduciary, a private operating foundation and the like. In such an arrangement, the maximum layers and, thereby associated costs, are removed. The multi-option hurdle rates allow the fiduciary manager 104 to allocate money that benchmarks different asset classes while only needing to interface with the investment manager 150. In one embodiment, the fiduciary manager 104 avoids payment of management fees and a percentage of the profit unless the investment manager 150 exceeds the selected hurdle rate(s). The investment manager 150, in turn, distributes the money in order to meet the objectives of the fiduciary manager 104, exceed the selected hurdle rate(s) and, thereby, garner compensation.

In one embodiment, the multi-option hurdle rates option has an investment option for a fixed rate of return. The fixed rate of return, such as 15%, would typically appeal to endowments, large net worth individuals and the like. Another investment option is at least one index plus a premium. In a particular embodiment, the index relative returns offered are a premium of: 1,000 basis points above the Merrill Lynch 3-month U.S. treasury bill index; 500 basis points above the Standard & Poor's 500; 500 basis points above the MidCap 400; 500 basis points above the MSCI Europe Stock index or MSCI World Stock index (positive or negative); a top quartile performance with respect to a private equity market index (positive or negative); and a top quartile performance with respect to a hedge fund index (positive or negative). As would be recognized by those of ordinary skill in the art, the former option addresses interest in various asset classes such as mutual funds, wide index funds, hedge funds and event based arbitrage funds. The index could be global index now known and later developed such as the NASDAQ, S&P 500 performance, a Russel 2000 performance, a U.S. Treasury performance, a MSCI Europe performance and a Dow Jones Industrials. In another embodiment, the investment manager 150 reduces the premium as a fund created with the multi-option hurdle rates option has success and seeks less capital. In another embodiment, the investment manager 150 varies other parameters such as the excess profit sharing arrangement depending upon desire for additional assets to employ.

Alternatively, the investment manager 150 establishes relationships with the other entities 108, 110, 112 by offering a multi-option hurdle rates option when co-investing with the investment manager 150. The investment manager 150 may also forego any management related fee and simply receive compensation through exceeding the hurdle rate. In one embodiment, the investment manager 150 receives half of the excess profits above the hurdle rate. Accordingly, costs and fees that do not properly motivate the investment manager 150 are removed as the investment manager's interests are aligned with the employees interest. The managers 104, 108, 110, 112 can easily evaluate the investment manager's real performance because the returns have no hidden costs that are susceptible to manipulation. In short, the evaluation is return on cash instead of an accounting concept. In other embodiments, the evaluation is return on other accounting methods such as, without limitation, accrual accounting.

It is also envisioned that the investment manager 150 would utilize the assets to assume control of a company. The investment manager 150 preferably revamps the company management team, culture and operations to close the value gap. One way of rejuvenating the controlled company is to in part incentivize certain executives according to the multi-option hurdle rates option. These certain executives receive compensation upon exceeding the hurdle rate and forego excessive salary, if any at all, and industry standard incentive compensation such as stock options, restricted stock and large cash bonuses. In another embodiment, the investment manager 150 and certain executives receive nominal base compensation for a predefined period. In one embodiment, the certain executives are only those executives who have provided substantial and significant value added prior to an acquisition.

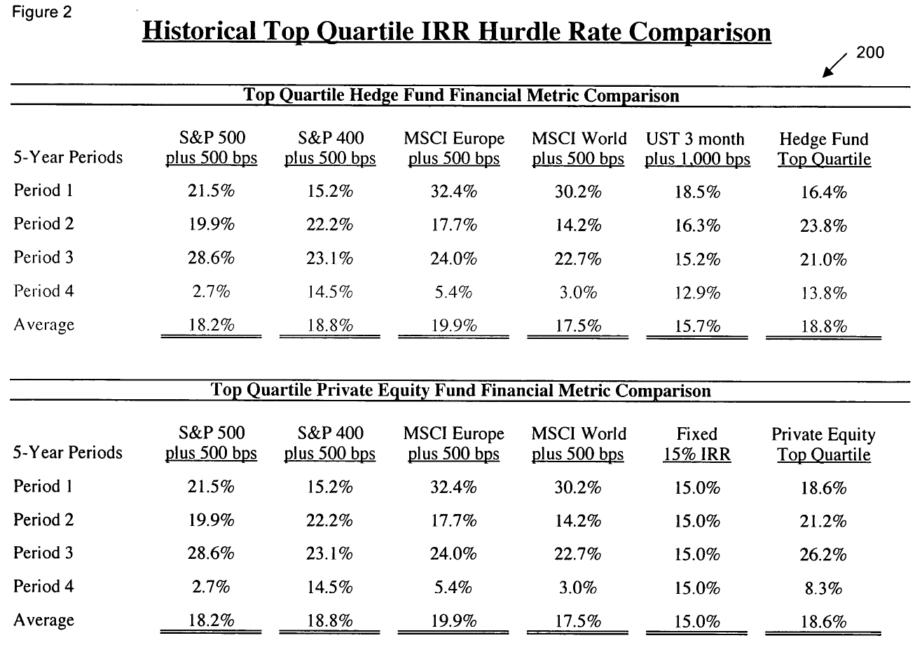

Referring now to FIG. 2, a table of exemplary data comparing hurdle rate over historical periods is shown and referred to generally by the reference numeral 200. The table 200 includes a comparison of five commonly used benchmarks with a hedge fund index over four consecutive time periods. The table 200 also includes a comparison of five benchmarks with a private equity index over four consecutive time periods. The specific percentages indicate the returns or performance required to be within the top quartile. Such data is used by fiduciaries in an effort to properly distribute assets under management. It is envisioned that a entity, who is engaging the investment manager 150, is presented with a financial product that has one or more hard hurdles based upon any index such as the ones shown. Additionally, the entity can weight or vary the distribution of assets differently within the selected indices depending upon the specific risk and reward objectives.

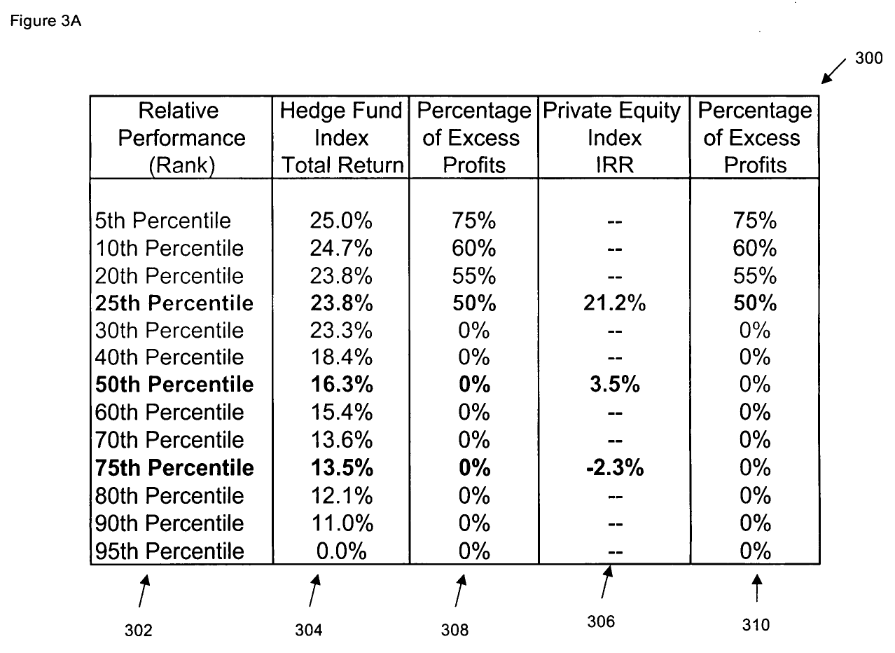

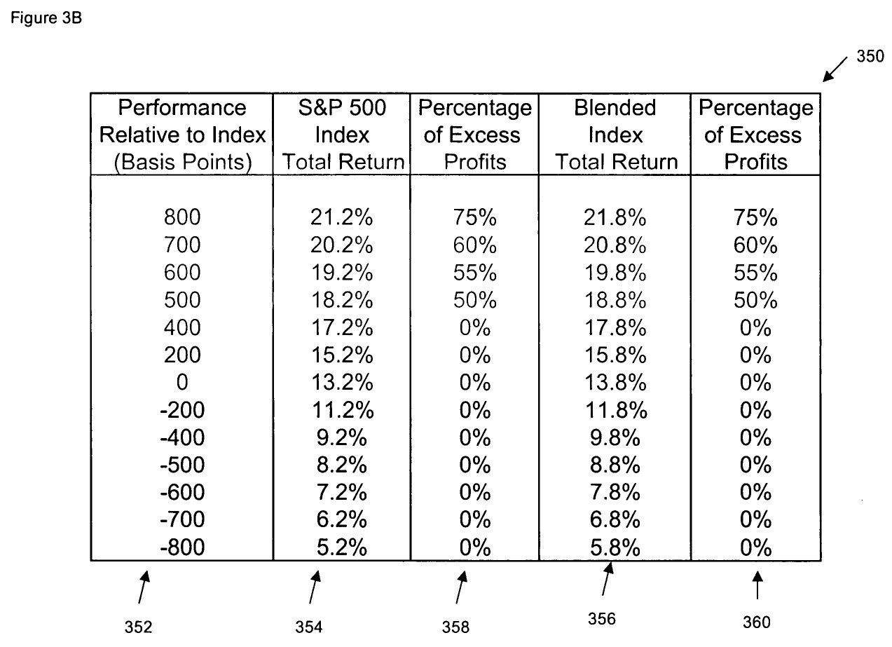

Referring to FIG. 3A, a table of an exemplary compensation scheme is shown and referred to generally by the reference numeral 300. The table 300 illustrates a range 302 of performance percentiles in 5% increments. As would be appreciated by those of ordinary skill in the pertinent art, any level of increments can be used such as quintiles, quartiles, deciles and combinations thereof. Associated with each performance percentile is a hedge fund index return 304 and a private equity index 306. Each index 304, 306 has a specific compensation scheme for the investment manager 150 that manages the money. In one embodiment, the compensation scheme does not include a management fee and is solely based on the respective percentages of excess profits 308, 310. For example, the hedge fund index return 304 requires the investment manager 150 to perform comparably to the top quartile thereof or forego any compensation. However, if the investment manager 150 clears this hard hurdle, compensation escalates rapidly from 50% of the excess profits between the performance level of the 25^{th} percentile and the 20^{th} percentile. Upon exceeding the 20^{th} percentile, the investment manager 150s compensation increased to 55% of the excess profits and so on. Upon presentation with a financial product having these hurdles, the entity allocating the assets can select one or more hard hurdles based upon the asset allocation preference of the investor. It is envisioned that the distribution of the excess profits follows a different granular stratification for each hurdle option as would be appropriate under given risk to reward preference of the investor.

Referring to FIG. 3B, another table of an exemplary compensation scheme is shown and referred to generally by the reference numeral 350. The table 350 is similar to table 300 and thus the following discussion is directed to the primary differences and comparable reference numerals for like items are “50” numbers higher. In table 350, the granular stratification of the performance hurdle is relative to an amount measured in basis points which the investment manager 150 must exceed the performance of the selected index rather than rank performance.

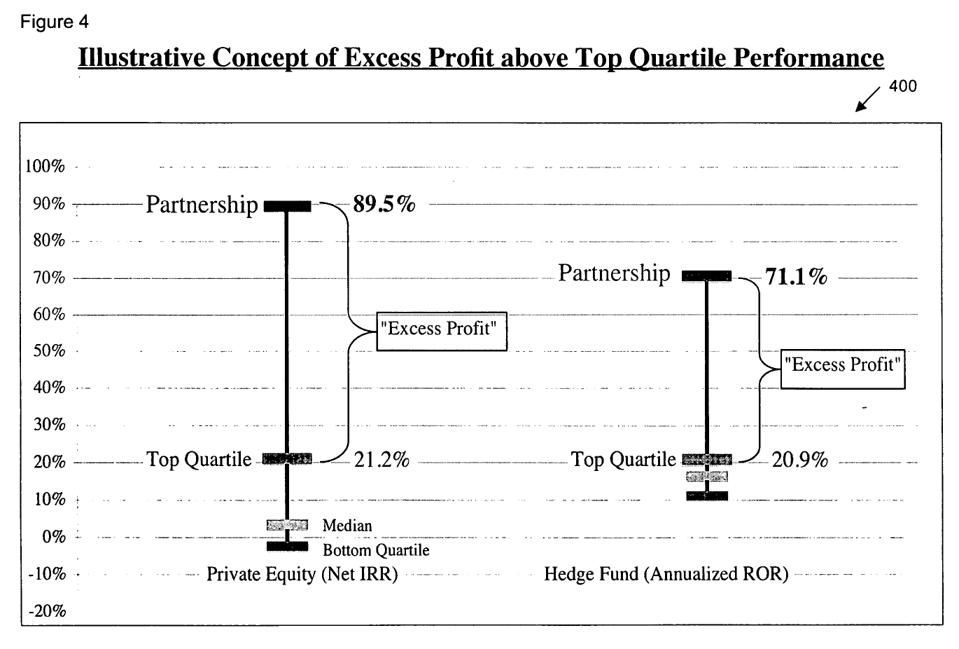

Referring now to FIG. 4, a graph 400 illustrates exemplary performance data in accordance with a compensation scheme of the subject technology. In the graph 400, the investment manager 150 is under a compensation scheme that required performance in the top quartile prior to compensation. For the excess profits (e.g., returns above the threshold at the 25^{th} percentile), the investment manager 150 receives a flat 50% thereof.

As can be seen from the description above, financial products in accordance with the subject technology use benchmarks to determine performance. Upon review of performance of the benchmark(s) and the investment manager 150 over the relevant time period, the performance data is utilized in a distribution scheme which determines compensation as a function of creating excess return. Basing the compensation solely on the excess return, attracts only the most talented and confident individuals to the investment manager 150 and financial structure.

In summary, the financial product in accordance with the subject technology provides superior performance for investors and entrepreneurial level compensation for the provider of the financial product. The financial product is further structured to entice investors while restraining investment unless significant opportunities are present. In other words, although investors and managers have minimal risk and, in turn, will seek out the investment manager 150 for access to the financial product, in order to clear the high hurdle(s), the investment manager 150 will refrain from accepting funds unless the funds can be effectively employed. Thus, the financial product removes the incentive for managers to simply amass large amounts of capital and collect a management fee based thereon. The financial product is offered in a co-investment structure basing investment manager compensation solely on excess profits, actually cultivating entrepreneurial returns. In particular, the best entrepreneurial investment managers, singularly focused on achieving excess profit with respect to a top quartile benchmark, excel with the co-investment structure.

Unless otherwise specified, the illustrated embodiments can be understood as providing exemplary features of varying detail of certain embodiments, and therefore, unless otherwise specified, features, components, modules, elements, and/or aspects of the illustrations can be otherwise combined, interconnected, sequenced, separated, interchanged, positioned, and/or rearranged without materially departing from the disclosed systems or methods. Additionally, the shapes and sizes of components are also exemplary and unless otherwise specified, can be altered without materially affecting or limiting the disclosed technology.

While the invention has been described with respect to preferred embodiments, those skilled in the art will readily appreciate that various changes and/or modifications can be made to the invention without departing from the spirit or scope of the invention as defined by the appended claims.

What is claim is:

1. A financial product offered by an entity to an investor comprising:
a plurality of indices;
a plurality of hurdles based on the plurality of indices, wherein each hurdle is selected by the investor for a portion of an investment of the investor;
a blended hurdle calculated as a weighted average of the selected hurdles according to allocation of the portions of the investment; and
a stratified compensation schedule associated with the blended hurdle such that as a return of the financial product increases above the blended hurdle, compensation for the entity increases.

2. A financial product as recited in claim 1, wherein the plurality of hurdles are negotiated between the investor and the entity and the blended hurdle is calculated retroactively over the relevant time period.

3. A financial product as recited in claim 1, wherein the financial product is aggregated by an intermediary for offering to a plurality of investors, compensation to the intermediary being based on a flat fee percentage of the investment.

4. A financial product as recited in claim 1, wherein the financial product is aggregated by an intermediary for offering to a plurality of investors, compensation to the intermediary being a percentage of excess profits above the blended hurdle.

5. A financial product as recited in claim 1, wherein the blended hurdle is top quartile performance measured against an index.

6. A financial product as recited in claim 1, wherein each hurdle is negotiated between the entity and the investor.

7. An entity having a co-investment financial structure comprising:
an employee that deploys assets; and
a stratified compensation schedule associated with at least one hurdle such that as a return on the assets exceeds the at least one hurdle, an incentive compensation for the employee is based on a percentage of the return in excess of the at least one hurdle instead of stock options and restricted stock options.

8. An entity as recited in claim 7, wherein the percentage varies according to rank relative to an index associated with the at least one hurdle and the employee is selected from the group consisting of president, chief financial officer, chief executive officer, chairman of the board, vice presidents and combinations thereof.

9. A method for allocating investment assets of an institutional investor stakeholder comprising the steps of:
a. providing an option for determining employment of a portion of the investment funds, the option being directed those asset managers seeking a fixed return on their assets, such as wealthy individuals or endowments;
b. providing an option for determining employment of a portion of the investment funds, the option being directed to those asset managers whose performance is measured relative to one of many stock-related stock indicies, such as many mutual funds or financial advisors; and
c. providing an option for determining employment of a portion of the investment funds, the option being directed to whose performance is measure relative to some fixed income or low volatility index, such as hedge funds or other absolute return managers.

10. A method as recited in claim 9, wherein the option is fixed rate of return, the option is a percentage above an S&P 500 or MSCI Europe performance and the option is a percentage above a U.S. treasury performance.

11. A method for in part compensating certain executive team members that controls an investment of a stakeholder comprising the steps of:
basing compensation of certain executive team members upon performance of the investment exceeding an index, wherein the performance must exceed the index before the certain executive team members is compensated; and
foregoing any other fee.

12. A method as recited in claim 11, wherein the index is a stock based performance index.

13. A method as recited in claim 11, wherein the index is a fixed or floating income-based performance index.

14. A method as recited in claim 13, wherein components of the index are selected from the group consisting of bonds, bills, notes, asset backed securities, combinations thereof and like instruments.

15. A method as recited in claim 14, further comprising the step of compensating certain executive team members by dividing additional profits at a first fixed percentage for the stakeholder and a second fixed percentage for certain executive team members after the performance exceeds the index.

16. A method as recited in claim 15, wherein the first and second fixed percentages are equal.

17. A method for efficiently establishing an investment structure, the investment structure having a stakeholder that benefits from aligned interests with an investment manager, the method comprising the steps of:
presenting to the stakeholder a multi-option hurdle rates that determines how the investment manager draws compensation from the investment structure, wherein the multi-option hurdle rates includes a first option of a rate of return based upon a premium above a first index and a second option of a fixed rate of return, wherein the multi-option hurdle rates further includes a third rate of return based upon a premium above another index; and
foregoing, by certain executive team members, a management fee based upon a percentage of assets under management.

18. A method as recited in claim 17, further comprising the steps of:
acquiring control of a company by the investment manager by utilizing funds of the stakeholder;
installing a management team at the company; and
compensating certain executive team members through the multi-option hurdle rates.

19. A method as recited in claim 17, wherein the vertical investment structure has an entity for providing a plurality of investment options to the stakeholder, each such investment option being selected from the group consisting of a hedge fund, a private equity fund and financial advisors such that a member selected from the group allocates assets between the first and second option.

20. A method as recited in claim 17, wherein the vertical investment structure has an entity for employing a plurality of investment managers, who, in turn, utilize the investment manager to manage at least one company and the premium decreases over time.
